(19) United States
(12) Patent Application Publication
(10) Pub. No.: US 2024/0184978 A1
(43) Pub. Date: Jun. 6, 2024

(54) DIGITAL PLATFORM AND METHODS FOR MANAGING DIGITAL APPLICATION FORMS

(71) Applicant: Prajwol Dhungana, Lewis Center, OH (US)

(72) Inventor: Prajwol Dhungana, Lewis Center, OH (US)

(21) Appl. No.: 18/528,087

(22) Filed: Dec. 4, 2023

Related U.S. Application Data
(60) Provisional application No. 63/429,830, filed on Dec. 2, 2022.

(51) Int. Cl. G06F 40/174; H04L 9/40

(52) U.S. Cl. CPC G06F 40/174; H04L 63/08

(57) ABSTRACT

A method for generating electronic documents includes receiving a first request to generate an electronic form, the electronic form including one or more fields. The method also includes generating a system identifier for at least one field of the one or more fields. The system identifier uniquely identifies the at least one field. Further, the method includes receiving, from a remote device over a network, a second request to complete the electronic form. Additionally, the method includes providing the system identifier to the remote device. The method includes receiving, from the remote device over the network, a completed version of the electronic form including personal user data corresponding to the at least one field. The personal user data was retrieved from storage on the remote device using the system identifier.

### CROSS-REFERENCE TO RELATED APPLICATIONS

This application claims the benefit of priority of U.S. provisional application No. 63/429,830, filed Dec. 2, 2022, entitled “Web and mobile applications to create, manage and process digital application forms. Web application will create, publish, and process digital application forms. Mobile application will search, view, and submit forms. Mobile app also autofilled the application form from the information and documents stored in the Mobile application,” the entire contents of which are herein incorporated by reference.

### FIELD

The present invention relates to network document management system.

### BACKGROUND

Now in the digital world, online users have to provide the same information again and again to fill the digital forms. Currently, there is no global system to read and write the form fields and required documents.

As can be seen, there is a need for electronic systems that improve the creating, management, and storage of electronic documents.

### SUMMARY

In one aspect of the present disclosure, a method for generating electronic documents includes receiving a first request to generate an electronic form, the electronic form including one or more fields. The method also includes generating a system identifier for at least one field of the one or more fields. The system identifier uniquely identifies the at least one field. Further, the method includes receiving, from a remote device over a network, a second request to complete the electronic form. Additionally, the method includes providing the system identifier to the remote device. The method includes receiving, from the remote device over the network, a completed version of the electronic form including personal user data corresponding to the at least one field. The personal user data was retrieved from storage on the remote device using the system identifier.

In another aspect of the present disclosure, a computer-readable medium stores instructions for causing one or more processors to perform a method. The method includes receiving a first request to generate an electronic form, the electronic form including one or more fields. The method also includes generating a system identifier for at least one field of the one or more fields. The system identifier uniquely identifies the at least one field. Further, the method includes receiving, from a remote device over a network, a second request to complete the electronic form. Additionally, the method includes providing the system identifier to the remote device. The method includes receiving, from the remote device over the network, a completed version of the electronic form including personal user data corresponding to the at least one field. The personal user data was retrieved from storage on the remote device using the system identifier.

In another aspect of the present disclosure, a system includes one or more memory devices storing instructions and one or more processors. The one or more processors are configured to execute the instructions to perform a method. The method includes receiving a first request to generate an electronic form, the electronic form including one or more fields. The method also includes generating a system identifier for at least one field of the one or more fields. The system identifier uniquely identifies the at least one field. Further, the method includes receiving, from a remote device over a network, a second request to complete the electronic form. Additionally, the method includes providing the system identifier to the remote device. The method includes receiving, from the remote device over the network, a completed version of the electronic form including personal user data corresponding to the at least one field. The personal user data was retrieved from storage on the remote device using the system identifier.

### BRIEF DESCRIPTION OF THE DRAWINGS

FIG. 1 is a high level flow diagram of a document management process, according to aspects of the present disclosure;

FIG. 2 is a system diagram of a network documents management system, according to aspects of the present disclosure;

FIG. 3 is a flow diagram of a relationship of components of the network documents management system of FIG. 2, according to aspects of the present disclosure; and

FIG. 4 is a flow diagram of connections of components of the network documents management system of FIG. 2, according to aspects of the present disclosure.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a system and process for network applications that solve the problem of creating digital forms and publishing digital forms. The systems and processes solve the problem of viewing and searching digital forms in a single platform and saving the information and data into user devices, e.g., mobile applications, and auto-fill the forms.

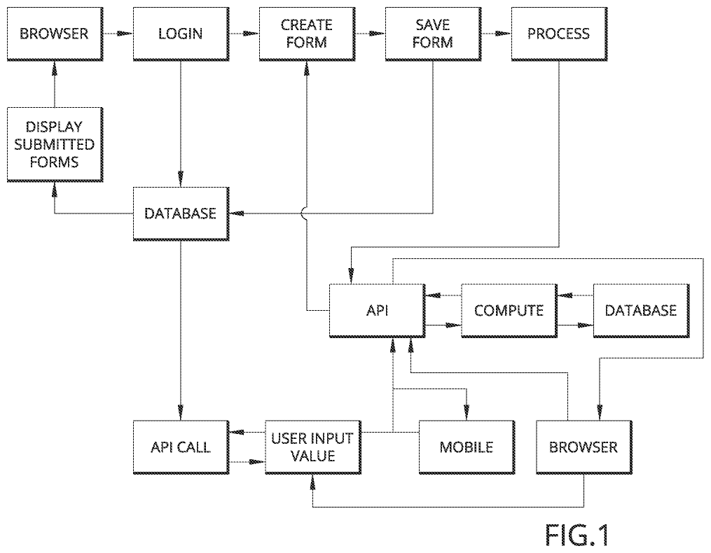

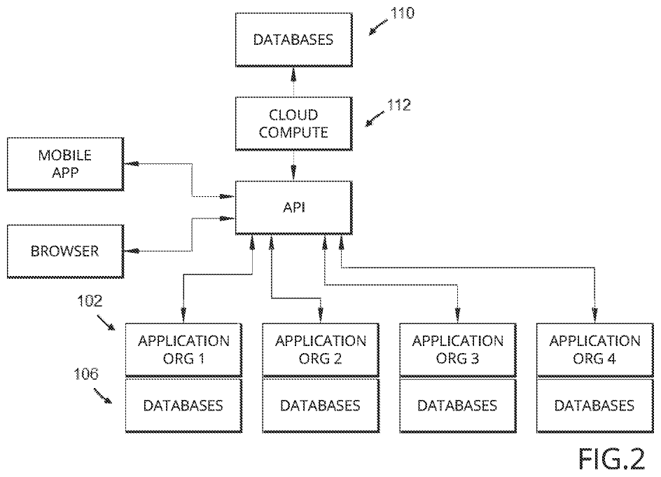

Referring now to FIGS. 1-4, FIG. 1 illustrates a high-level process diagram for creating and managing digital forms in a network environment, according to aspects of the present disclosure. While FIG. 1 illustrates various stages of the process, additional stages can be added, and existing stages can be removed and/or reordered. FIGS. 2-4 illustrate components of a network document management system including a web application 102 and a mobile application 104 for creating and managing digital forms in a network environment, according to aspects of the present disclosure. While FIGS. 2-4 illustrate various components of the network document management system, additional components can be added, and existing components can be removed.

In embodiments, a web application 102 provides a system for creating, storing, managing, sharing, and publishing digital forms in a network environment. The web application 102 has a function to create the digital forms and publish the digital forms on the platform for website and the mobile application 104. Using the mobile application 104, users can store personal information and documents associated with them and their dependents. While creating the digital form, the web application 102 can read values from the one or more databases, e.g., a database 106. The databases store data in a data structure for each form different form fields and document lists. When a form is created, each form field and document can utilize a unique system identification number (system ID) associated with the form field and/or document. Once the application form is published on platform, the form can be view from the mobile application 104. The mobile function can read the unique system ID and auto-fill the application form with information associated with the unique system ID.

The mobile application 104 also has one or more local databases, e.g., database 108, to store the personal information and documents for the main user and their dependents. Personal information and documents are stored in a data structure with a unique system ID. All the information and documents are stored within the mobile application 104, itself. When the user opens the form, the mobile application 104 detects the system ID on the form and fetches the same system ID from the mobile database 108. The mobile application 104 fills the form automatically using the data stored in the mobile database 108. Users store details on the mobile application 104 for one time only, then the same information and documents can be used for all other application forms. The user are not required to provide repetitively provide the same information. Using the mobile application 104, the user enter the information once, and the information is stored once in the mobile application 104. Accordingly, the mobile application 104 can handle what information and documents need to be sent to what application form. The mobile application 104 includes logic, programing, algorithms, and code to send the application form to related organizations.

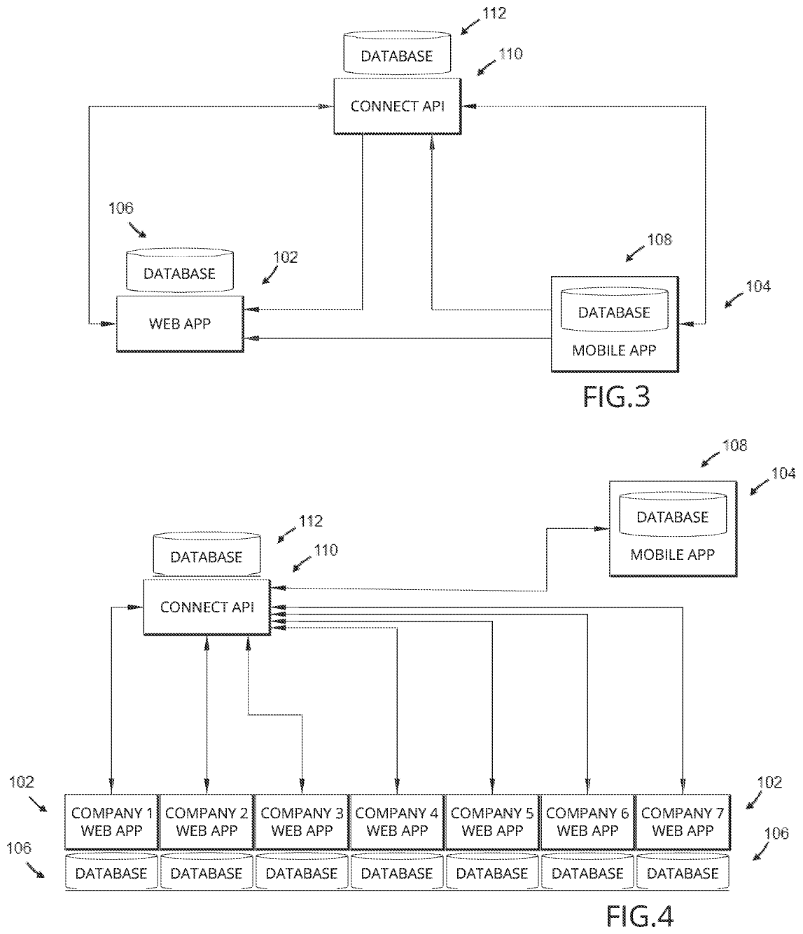

As illustrated in FIG. 3, the network document management system can include three components, the web application 102, the mobile application 104, and a connect API 110. The web application 102 can create, publish and manage digital application forms. The database 106, associated with the web application 102, can store form Fields and document data. Table 1 illusrates an example of the System ID and associated fields, data, and forms.

TABLE 1

| System | | | Data | |
|---|---|---|---|---|
| ID | Display Name | Data Type | Description | Data For |
| PI002 | First Name | Varchar | Legal First | Form Field |
| | | | Name | |
| LD001 | Birth Certificate | Jpg/pdf | Birth | Document |
| | | | Certificate | Field |

Admin Users, e.g., admins of the web application 102, representatives of businesses and organizations, etc., can login to the system and can create a form with data fetched from this database 106. The database 106 has all the common form fields and documents that are used in most of the forms in the world in different languages. For example, the database 106 can store more than 300 unique system IDs in the database 106 for English language only. Users can create custom form fields as well. After creating the form, users can review and publish the form on platform, website of the network application 102 and/or the mobile application 104.

Once published, the form will be available to the public through online and on the mobile application 104. By creating a form with the web application 104, the system ID for each form field and document can be the same on the website and the mobile application 104. In use, the user may not see the system ID, but can see the display name on graphical user interfaces (GUIs) generated by the mobile application 104 or the website.

The connect API 110 is another application for the network document management system. The connect API 110 manage the form details and connection between the web application 102 and the mobile application 104. The connect API 110 makes connections between the web applications 102 and the mobile applications 104. The connect API 110 includes logic, programing, algorithms, and code to manage organizations, manage the form status, form categories, form publish time, and sending form details to the mobile application 104. The connect API 110 app also manages the system ID between the web application 102 and the mobile application 104. The connect API 110 may not a customer facing application.

The mobile application 104 is another application for the network document management system. The mobile application 104 to view, seach, and apply all digital application forms from different organizations that are published on Platform. The mobile application 104 is for the end users who need to submit a digital application form. On the mobile application 104, users can view the forms in different categories, search the form, and store the personal information for themselves and their dependents in a structured manner. All the personal information and documents stored on the mobile application 104 are stored on the mobile application 104 only in the local database 108 on a user's electronic device. This is one of the security features of the mobile application 104 that prevents the user's personal and private information from being transmitted on public networks. The mobile application 104 can auto-fill the form fields and attach documents for the form using the stored information. Users are not required to repeatedly fill in the same information again and again if stored in the mobile app. If the user has stored information for more than one dependent, then the user can select the required dependent to fill forms. In operation, users can verify the details on the GUIs of the mobile application 104. Once all the required information and document are filled, the user can submit the form to the web application 102. The web application 102 send the complete form to the corresponding organization, recipient, etc.

In embodiments, as illustrated in FIG. 4, the web application 102 includes features to create, publish and manage digital application forms. The web application 104 includes the database 106, which stores different tables, as discussed above. For example, the database 106 includes one table to store the form fields and form documents after receiving details from the connect API 110. Other tables can store data for created forms and submitted application form details. As illustrated in FIG. 4, each organization can operate a copy of the web application 102 connected to a database 106.

As discussed above, the connect API 110 is an application to manage all the business logic for the form details and connect between the web application 102 and the mobile application 104. This application is connected to a database 112 which has different tables to manage different details. One of the table has all the form fields and documents details which feeds data to the web application 102 and the mobile application 104 with systemID.

As discussed above, the mobile application 104 allow a user to view, search and submit digital application forms from different organizations. It also has a feature to store personal information and documents for users and their dependents in a very organized way. The personal information and documents are stored within the database 108 of the mobile application 104, which is locally stored on a user device. Users will have full control of their data. As such, no user personal information and documents are stored remotely on systems associated with the web application 102 or the connect API 110. To store personal information and documents, for example, the user can signup/signin with one of the valid Mobile Number, Email, Facebook, Apple (for Apple device only) or Gmail Account.

FIG. 1 illustrates to process for creating and completing forms using the network document management system. As discussed, the admin user creates a form, and can publish the form for the platform-mobile application 104. When user click on publish, all the content of the form including form name, form number, form start date, form end date, form description, images URL, form field details and document details are sent to the connect API 110.

Then, the connect API 110 can store the information into the database 112 and process the form details. When a mobile user opens the mobile application 104, the mobile application 104 calls the connect API 110 to get all the active forms. The connect API 110 sends all active form summaries to the mobile application 104. The users can see the form summary on one or more GUIs, e.g., the Home page. The forms can be categorized into different domains. The mobile application can have logic to display as per the form category.

When a user selects a specific form, the mobile application 104 makes another call to the connect API 110 with the form number. Then, the connect API 110 sends form details which includes organization name, form end date, form description, form number, image URL, form field details, and document details with system ID to the mobile application 104.

If the user is logged in, the mobile application 104 can make a call to connect API 110 to get profile details in order to create a profile and save details. The connect API 110 can send all the profile details with system ID. The mobile application 104 can show profile details in UI and user input personal information and documents and save it. All the information and documents are saved within the database 108.

Once form fields are filled and documents are attached (if required) in a mobile application 104, the user can select a submit button in the GUIs. The filled application form can be sent to the web application 102 to the related organization through API (see FIGS. 2 and 3). If the user has a login and saved the personal information and documents, the mobile application 104 can auto-fill the form fields and attach the required documents.

Once the web application 102 successfully receives the application details and response is sent back to the mobile application 104, the mobile application 104 sends application history details to the connect API 110, which include form name, form number, reference number and date only. No form field information and document details are sent to connect API 110. The connect API 110 sends form fields and documents details to the web application 102. This process synchronizes information in the web application 102 and the connect API 110. If any update on the connect API 110 database for form fields, the web application and mobile application can be updated.

In the process above, to use the system, an organization needs to register their organization details into the Connect API 110. The information can be reviewed and validated. Once the organization registration and validation process is completed, a copy of the web application 102 can be deployed to a computer system associated with the organization, e.g., the server, cloud service, etc. Each organization can have their own domain/subdomain and database, email address, and Admin users. Then, the Admin user can login to their web application 102. User will create an application form. While creating the form, the user can select the form fields and documents from the list on the UI. The user can also create their own form fields and documents if not present in the list.

Then, the user can activate the form on a website and/or on Platform the mobile application 104. While Publishing on a mobile application 104, it sends the form details. For example, pseudo-code for form details sent to connect API 110 can be
{
“orgId”: 0,
“formNumber”: “string”,
“formFor”: “string”,
“startDate”: “2022-10-30T18:54:18.808Z”,
“endDate”: “2022-10-30T18:54:18.808Z”,
“formLogo”: “Url”,
“formDescription”: “formDescription”,
“formFields”: [
{
“systemID”: “PI001”,
“displayName”: “Title”,
“required”: true
},
{
“systemID”: “PI002”,
“displayName”: “First Name”,
“required”: true
}
{
“systemID”: “PI003”,
“displayName”: “Middle Name”,
“required”: false
}
{
“systemID”: “PI004”,
“displayName”: “Last Name”,
“required”: true
}
],
“formDocuments”: [
{
“systemID”: “LD001”,
“displayName”: “Birth Certificate”,
“required”: true
}
{
“systemID”: “LD002”,
“displayName”: “Citizenship”,
“required”: False
}
],
“crtUser”: “string”,
“crtDate”: “2022-10-30T18:54:18.808Z”
}

The connect API 110 can receive the information and store it in the database 112. The connect API 110 can process each form with all the business logics. When users open the mobile application 104, the mobile application 104 makes a call to the connect API 110. The connect API 110 sends all the forms summary to the mobile application 104. The mobile application 104 process the forms summary and display on the mobile UI.

For example, pseudo-code for form details summary can be
[
{
“formld”: 35,
“orgld”: 3,
“orgName”: “Digital Formulation LLC”,
“orgApiDetails”: “APIURL”,
“formNumber”: “3-36”,
“formFor”: “Demo-Employment”,
“formLogo”: “URL”,
“formCategory”: “Employment”,
“formTags”: [ ],
“formImages”: [
{
“imageName”: “Omniuse.png”,
“displayName”: “Omniuse.png”,
“url”: “url”
}
],
“formRanking”: 1
},
{
“formld”: 36,
“orgld”: 3,
“orgName”: “Digital Formulation LLC”,
“orgApiDetails”: “APIABC/Post/Form”,
“formNumber”: “7-39”,
“formFor”: “Demo-Edcuation”,
“formLogo”: “URL”,
“formCategory”: “Education”,
“formTags”: [
“Master”,
“omniuseapp”
],
“formImages”: [
{
“imageName”: “Omniuse.png”,
“displayName”: “Omniuse.png”,
“url”: “URL”
}
],
“formRanking”: 1
}
]

The forms that are published on their website can be seen through a web browser to all users over the internet. End users don't need to login to view the published forms. End users can fill in the details and submit the form. Once a form is submitted, Admin users can login to view the submitted form. Admin users can process the submitted forms as per their need.

To acquire the mobile application 104, users can download the the mobile application 102 from Apple Appstore for IOS device and from Google Play store for Android device. Once the mobile application 102 is installed, the users can open the mobile application 104 to view all digital application forms published by all organizations. Users can view forms under different categories. On the mobile application, a user doesn't need to login to view and apply any form. If a user wants to store information and documents in the mobile application 104, then the user can login. Users can signup/signin with valid email, Mobile number, Gmail, Facebook or Apple account. User tab on the form to view the form's details. Form details are displayed with form fields and documents details. Users can fill the form fields and attach the documents (if required) and click on the Submit button. A Form can be sent to the related organization through the connect API 110.

If the user had logged in and stored the value and documents on the Omniuse app, the form fields can be auto-fill and documents will be attached. Users need to review and click on the submit button. Once a form is submitted, Admin users can login to view the submitted form. Admin users can process the submitted forms as per their need.

In the processes and system above, the web application 102 and/or the connect API 110 can be stored and executed on a computer system. The computer system includes one or more processing devices, herein processing device, coupled to a communication device. The processing device is also coupled to a memory device, and an input/output (“I/O”) interface. In embodiments, the communication interface enables the computer system to communicate with other devices and systems via one or more networks. The computer system can communicate with a user device, storing and executing the mobile application 104, via the network. The user device can include one or more electronic devices such as a laptop computer, a desktop computer, a tablet computer, a smartphone, a thin client, a smart appliance, and the like. The computer system can also communicate with other computer systems storing and executing the web application 102 and the connect API 110.

The components of the computer system, e.g., the processing device, the communication device, the memory device, and the I/O interface can be interconnected via a system bus. The system bus can be and/or include a control bus, a data bus, and address bus, and so forth. The processing device can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device.

The memory device can be and/or include computerized storage medium capable of storing electronic data temporarily, semi-permanently, or permanently. The memory device 108 can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device.

The communication device can include, for example, a networking chip, one or more antennas, and/or one or more communication ports. The communication device can generate radio frequency (RF) signals and transmit the RF signals via one or more of the antennas. The communication device can generate electronic signals and transmit the RF signals via one or more of the communication ports. The communication device can receive the RF signals from one or more of the communication ports. The electronic signals can be transmitted to and/or from a communication hardline by the communication ports. The communication device can generate optical signals and transmit the optical signals to one or more of the communication ports. The communication device can receive the optical signals and/or can generate one or more digital signals based on the optical signals. The optical signals can be transmitted to and/or received from a communication hardline by the communication port, and/or the optical signals can be transmitted and/or received across open space by the communication device.

The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

As described above, the computer system can include hardware components to perform the processes described herein. In embodiments, one or more of components, hardware, and/or functionality of the computer system can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the computer system can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “information,” “content,” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in executing the web application 102, the mobile application 104, and the connect Api 110 can provide I/O devices for outputting information in a format perceptible by a user and receiving input from the user. For example, I/O devices can display graphical user interfaces (“GUIs”) generated by the devices. The I/O devices can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The I/O devices can include an acoustic element such as a speaker, a microphone, and so forth. The I/O devices can include a button, a switch, a keyboard, a touch-sensitive surface, a touchscreen, a camera, a fingerprint scanner, and so forth. The touchscreen can include a resistive touchscreen, a capacitive touchscreen, and so forth.

It should be understood, of course, that the foregoing relates to exemplary embodiments of the invention and that modifications can be made without departing from the spirit and scope of the invention as set forth in the following claims.

What is claimed is:

1. A method for generating electronic documents, the method comprising:
receiving a first request to generate an electronic form, the electronic form comprising one or more fields;
generating a system identifier for at least one field of the one or more fields, wherein the system identifier uniquely identifies the at least one field;
receiving, from a remote device over a network, a second request to complete the electronic form;
providing the system identifier to the remote device; and
receiving, from the remote device over the network, a completed version of the electronic form including personal user data corresponding to the at least one field, wherein the personal user data was retrieved from storage on the remote device using the system identifier.

2. The method of claim 1, the method further comprising:
receiving, from the remote device over the network, a third request to complete a second electronic form, wherein the second electronic form is different from the electronic form, and the second electronic form include the at least one field;
providing the system identifier to the remote device; and
receiving, from the remote device over the network, a completed version of the second electronic form including personal user data corresponding to the at least one field, wherein the personal user data was retrieved from storage on the remote device using the system identifier.

3. The method of claim 2, wherein the at least one field comprises an alpha numeric data field or a document attachment field.

4. The method of claim 1, the method further comprising:
receiving login information from a user of the remote device;
authenticating the login information;
receiving the personal user data from the user; and
storing, on the remote device, the personal user information associated with the system identifier.

5. The method of claim 1, wherein the second request is received via an application programming interface all.

6. A computer-readable medium storing instructions that cause one or more processors to perform a method, the method comprising:
receiving a first request to generate an electronic form, the electronic form comprising one or more fields;
generating a system identifier for at least one field of the one or more fields, wherein the system identifier uniquely identifies the at least one field;
receiving, from a remote device over a network, a second request to complete the electronic form;
providing the system identifier to the remote device; and
receiving, from the remote device over the network, a completed version of the electronic form including personal user data corresponding to the at least one field, wherein the personal user data was retrieved from storage on the remote device using the system identifier.

7. The computer-readable medium of claim 6, wherein the instructions cause one or more processors to perform the method further comprising:
receiving, from the remote device over the network, a third request to complete a second electronic form, wherein the second electronic form is different from the electronic form, and the second electronic form include the at least one field;
providing the system identifier to the remote device; and
receiving, from the remote device over the network, a completed version of the second electronic form including personal user data corresponding to the at least one field, wherein the personal user data was retrieved from storage on the remote device using the system identifier.

8. The computer-readable medium of claim 6, wherein the second request is received via an application programming interface all.

9. A system comprising:
one or more memory devices storing instructions; and
one or more processors configured to execute the instructions to perform a method, the method comprising:
receiving a first request to generate an electronic form, the electronic form comprising one or more fields;
generating a system identifier for at least one field of the one or more fields, wherein the system identifier uniquely identifies the at least one field;
receiving, from a remote device over a network, a second request to complete the electronic form;
providing the system identifier to the remote device; and
receiving, from the remote device over the network, a completed version of the electronic form including personal user data corresponding to the at least one field, wherein the personal user data was retrieved from storage on the remote device using the system identifier.

10. The system of claim 9, further comprising:
the remote device, wherein the remote device is configured perform another method comprising:
receiving login information from a user of the remote device;
authenticating the login information;
receiving the personal user data from the user; and
storing, on the remote device, the personal user information associated with the system identifier.
